(19) United States
(12) Patent Application Publication
(10) Pub. No.: US 2024/0326855 A1
(43) Pub. Date: Oct. 3, 2024

(54) IN-VEHICLE EQUIPMENT SETUP DEVICE, IN-VEHICLE EQUIPMENT SETUP METHOD, AND STORAGE MEDIUM

(71) Applicant: HONDA MOTOR CO., LTD., Tokyo (JP)

(72) Inventors: Kyoko Iwashima, Tokyo (JP); Junya Ishizaki, Tokyo (JP); Naoki Kikuchi, Tokyo (JP); Yoshihiro Matsugi, Tokyo (JP); Haruka Kubo, Tokyo (JP); Naoki Shibata, Tokyo (JP); Yunan Cai, Tokyo (JP); Yoshiaki Inoue, Tokyo (JP); Takaya Higuchi, Tokyo (JP); Shohei Kamochi, Tokyo (JP); Satoshi Yamashita, Tokyo (JP); Tomohiro Suzuki, Tokyo (JP)

(21) Appl. No.: 18/583,908

(22) Filed: Feb. 22, 2024

(30) Foreign Application Priority Data
Mar. 29, 2023 (JP) 2023-052651

(51) Int. Cl. B60W 50/14; B60W 50/00

(52) U.S. Cl. CPC B60W 50/14; B60W 2050/0083; B60W 2050/146; B60W 2520/10; B60W 2540/215

(57) ABSTRACT

An in-vehicle equipment setup device includes: a storage configured to store user setting information including settings of in-vehicle equipment desired by a user; a setter configured to set a set value in the user setting information of a selected user for the corresponding in-vehicle equipment; a settings comparator configured to acquire a current set value from the in-vehicle equipment and to compare the acquired current set value with a user set value which is a set value in the setting information included in the user setting information of the selected user; and a notifier configured to notify the user. When there is non-set in-vehicle equipment which is in-vehicle equipment of which the user set value is different from the current set value according to a result of the comparison, the settings comparator causes the notifier to notify that there is non-set in-vehicle equipment on the basis of travel information including a traveling state of the vehicle. The setter sets the user set value for the non-set in-vehicle equipment on the basis of the travel information when a setting instruction for instructing to set the user set value for the non-set in-vehicle equipment is input by the user.

### CROSS-REFERENCE TO RELATED APPLICATION

Priority is claimed on Japanese Patent Application No. 2023-052651, filed Mar. 29, 2023, the content of which is incorporated herein by reference.

### BACKGROUND OF THE INVENTION

### Field of the Invention

The present invention relates to an in-vehicle equipment setup device, an in-vehicle equipment setup method, and a storage medium.

### Description of Related Art

In the related art, techniques of setting settings for operating a variety of in-vehicle equipment mounted in a vehicle for each user of the vehicle are disclosed (for example, see Japanese Unexamined Patent Application, First Publication No. 2022-152073). Recently, settings of in-vehicle equipment have been set in conjunction with a wireless portable key such as a smart key according to a user carrying a portable key.

When an operation of in-vehicle equipment is set according to a user, it is preferable that setting of in-vehicle equipment be completed before a vehicle starts after the user gets in the vehicle, that is, before the user causes the vehicle to travel. Accordingly, in order to promptly recognize (identify) a user in the vehicle, an in-vehicle equipment setup device that performs setting of in-vehicle equipment suspends some functions, the in-vehicle equipment setup device is supplied with electric power from a battery provided in the vehicle, and an application which is executed by the in-vehicle equipment setup device is on standby in a substantially activated state. However, when the vehicle has been stopped for a long period of time (that is, no user is in the vehicle in a long term), electric power of the battery provided in the vehicle is consumed due to starting of the application. Accordingly, when the vehicle has been stopped for a long period of time, it is conceivable that the application be stopped and supply of electric power to the in-vehicle equipment setup device be cut off in order to curb power consumption of the battery in the vehicle.

However, when a user gets in the vehicle in a state in which supply of electric power to the in-vehicle equipment setup device has been cut off, the user can be recognized (identified) only after electric power is supplied to the in-vehicle equipment setup device to start the application. It takes a lot of time to complete setting of the in-vehicle equipment corresponding to the user in the vehicle. Accordingly, setting of the in-vehicle equipment may not be completed until the vehicle starts, and the function of performing setting of the in-vehicle equipment according to a user cannot be said to be highly convenient to a user. It is also conceivable that the in-vehicle equipment setup device perform setting of in-vehicle equipment of which setting is not completed until the vehicle starts while the vehicle is traveling. However, there may be in-vehicle equipment or settings which affect driving of the vehicle when the settings are changed while traveling. Accordingly, it is also conceivable that the in-vehicle equipment setup device do not perform setting of in-vehicle equipment of which setting is not completed until the vehicle starts while the vehicle is traveling. As described above, in the related art, a timing at which setting of in-vehicle equipment is performed may not be sufficiently considered when settings corresponding to a user are set for the in-vehicle equipment.

The present invention was made in consideration of the aforementioned circumstances, and an objective thereof is to provide an in-vehicle equipment setup device, an in-vehicle equipment setup method, and a storage medium that can perform setting of in-vehicle equipment according to a user at an appropriate timing. That is, an objective of the present invention is to improve convenience by performing setting or control of in-vehicle equipment according to a user. Another objective of the present invention is to contribute to development of a sustainable transportation system by further improving traffic safety.

### SUMMARY OF THE INVENTION

An in-vehicle equipment setup device, an in-vehicle equipment setup method, and a storage medium according to the present invention employ the following configurations.

(1) According to an aspect of the present invention, there is provided an in-vehicle equipment setup device for performing setting for activating in-vehicle equipment mounted in a vehicle for each user of the vehicle, the in-vehicle equipment setup device including: a storage configured to store user setting information including setting information on settings of in-vehicle equipment desired by a user for each user; a setter configured to set a set value indicated by the setting information included in the user setting information of a selected user for the corresponding in-vehicle equipment; a settings comparator configured to acquire a current set value which is a set value currently set from the in-vehicle equipment and to compare the acquired current set value with a user set value which is a set value indicated by the setting information included in the user setting information of the selected user; and a notifier configured to notify the user of at least information on settings of the in-vehicle equipment, wherein, when there is non-set in-vehicle equipment which is in-vehicle equipment of which the user set value is different from the current set value according to a result of the comparison, the settings comparator causes the notifier to notify that there is non-set in-vehicle equipment on the basis of travel information including a traveling state of the vehicle, and the setter sets the user set value for the non-set in-vehicle equipment on the basis of the travel information when a setting instruction for instructing to set the user set value for the non-set in-vehicle equipment notified by the notifier is input by the user.

(2) In the aspect of (1), the settings comparator acquires the current set value and compares the current set value with the user set value after the vehicle has started.

(3) In the aspect of (2), the in-vehicle equipment setup device further includes a communicator configured to perform communication between the in-vehicle equipment and a travel information presentation device for presenting the travel information of the vehicle to the user, and the settings comparator acquires the current set value via the communicator, acquires current travel information which is the travel information currently presented to the user by the travel information presentation device via the communicator, and causes the notifier not to notify that there is non-set in-vehicle equipment when the acquired current travel information satisfies a first condition.

(4) In the aspect of (3), the first condition is that the current travel information is the travel information of a type for calling attention to traveling of the vehicle.

(5) In the aspect of (3), the first condition is that the current travel information is the travel information which is automatically presented to the user by the travel information presentation device.

(6) In the aspect of (3), the setter acquires the current travel information via the communicator after the setting instruction has been input, suspends setting of the user set value for the non-set in-vehicle equipment when the acquired current travel information satisfies a second condition, and causes the notifier to notify that setting of the user set value for the non-set in-vehicle equipment is suspended.

(7) In the aspect of (6), the second condition is that the current travel information is the travel information indicating that a traveling speed of the vehicle is zero.

(8) According to another aspect of the present invention, there is provided an in-vehicle equipment setup method that is performed by a computer of an in-vehicle equipment setup device for performing setting for activating in-vehicle equipment mounted in a vehicle for each user of the vehicle, the in-vehicle equipment setup method including: setting, out of user setting information which is stored in a storage and includes setting information on settings of in-vehicle equipment desired by a user for each user, a set value indicated by the setting information included in the user setting information of a selected user for the corresponding in-vehicle equipment; acquiring a current set value which is a set value currently set from the in-vehicle equipment; comparing the acquired current set value with a user set value which is a set value indicated by the setting information included in the user setting information of the selected user; causing a notifier, which is configured to notify the user of at least information on settings of the in-vehicle equipment, to notify that there is non-set in-vehicle equipment on the basis of travel information including a traveling state of the vehicle when there is non-set in-vehicle equipment which is in-vehicle equipment of which the user set value is different from the current set value according to a result of the comparison; and setting the user set value for the non-set in-vehicle equipment on the basis of the travel information when a setting instruction for instructing to set the user set value for the non-set in-vehicle equipment notified by the notifier is input by the user.

(9) According to another aspect of the present invention, there is provided a non-transitory computer-readable storage medium storing a program, the program causing a computer of an in-vehicle equipment setup device for performing setting for activating in-vehicle equipment mounted in a vehicle for each user of the vehicle to perform: setting, out of user setting information which is stored in a storage and includes setting information on settings of in-vehicle equipment desired by a user for each user, a set value indicated by the setting information included in the user setting information of a selected user for the corresponding in-vehicle equipment; acquiring a current set value which is a set value currently set from the in-vehicle equipment; comparing the acquired current set value with a user set value which is a set value indicated by the setting information included in the user setting information of the selected user; causing a notifier, which is configured to notify the user of at least information on settings of the in-vehicle equipment, to notify that there is non-set in-vehicle equipment on the basis of travel information including a traveling state of the vehicle when there is non-set in-vehicle equipment which is in-vehicle equipment of which the user set value is different from the current set value according to a result of the comparison; and setting the user set value for the non-set in-vehicle equipment on the basis of the travel information when a setting instruction for instructing to set the user set value for the non-set in-vehicle equipment notified by the notifier is input by the user.

According to the aspects of (1) to (9), it is possible to provide an in-vehicle equipment setup device, an in-vehicle equipment setup method, and a storage medium that can perform setting of in-vehicle equipment according to a user at an appropriate timing.

### BRIEF DESCRIPTION OF THE DRAWINGS

FIG. 1 is a diagram illustrating an example of a configuration and a usage environment of an in-vehicle equipment setup device according to an embodiment.

FIG. 2 is a diagram illustrating an example of an environment in which information is presented in a vehicle in which the in-vehicle equipment setup device according to the embodiment is mounted.

FIG. 3 is a sequence diagram illustrating an example of a process flow of setting set values of in-vehicle equipment which is performed by the in-vehicle equipment setup device according to the embodiment.

FIG. 4 is a diagram illustrating an example of a notification screen for notifying a user when the in-vehicle equipment setup device according to the embodiment sets set values of in-vehicle equipment.

### DETAILED DESCRIPTION OF THE INVENTION

Hereinafter, an in-vehicle equipment setup device, an in-vehicle equipment setup method, and a storage medium according to an embodiment of the present invention will be described with reference to the accompanying drawings. As used throughout this disclosure, the singular forms “a,” “an,” and “the” include plural reference unless the context clearly dictates otherwise.

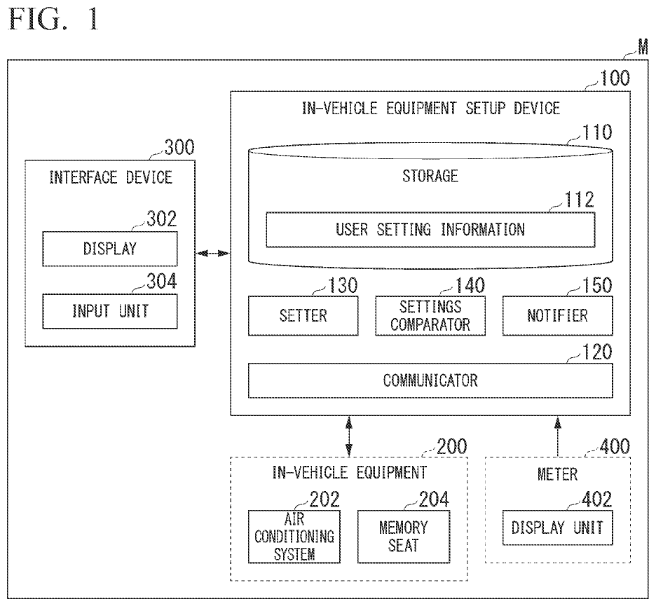

FIG. 1 is a diagram illustrating an example of a configuration and a usage environment of an in-vehicle equipment setup device according to an embodiment. The in-vehicle equipment setup device 100 is a device that sets or controls in-vehicle equipment 200 mounted in a vehicle M. Examples of the in-vehicle equipment 200 that is set or controlled by the in-vehicle equipment setup device 100 include a power window, a sunroof, a sunshade, an indoor lamp, a map light, an air conditioning system, a memory seat, a seat heater/cooler, a door lock, a driving mode setting device, and a driving support device.

The power window is, for example, in-vehicle equipment 200 for opening or closing windshields provided on a driver's seat side, a passenger's seat side, and right and left sides of rear seats of the vehicle M, and an amount of opening or closing or the like of the windshields corresponding to an amount of pressing or a pressing time in which an on/off switch is pressed by a user is set or controlled by the in-vehicle equipment setup device 100. The sunroof is, for example, in-vehicle equipment 200 for opening or closing a glass or steel panel or the like of an opening provided on the ceiling of the cabin of the vehicle M, and an amount of opening or closing the glass or steel panel according to a user's operation or the like is set or controlled by the in-vehicle equipment setup device 100. The sunshade is, for example, in-vehicle equipment 200 for opening or closing a light blocking part that blocks sunlight input from a windshield part on the rear of the vehicle M or right and left windshield parts of the rear seats, and an amount of opening or closing or the like of the light blocking part according to a user's operation is set or controlled by the in-vehicle equipment setup device 100. Each of the indoor lamp and the map light is, for example, in-vehicle equipment 200 (an illumination instrument) for lighting the cabin of the vehicle M or a user's hand, and turning-on or turning-off which is performed according to a user's operation or regardless of a user's operation, that is, manually or automatically, or brightness at the time of turning-on is set or controlled by the in-vehicle equipment setup device 100. The air conditioning system is, for example, in-vehicle equipment 200 (an air conditioning device) such as an air conditioner, and the temperature, the wind volume, and the like of air (wind) output to the cabin of the vehicle M are set or controlled by the in-vehicle equipment setup device 100. The memory seat is, for example, in-vehicle equipment 200 for changing a seat position of a driver's seat such that a position or height of a seat surface, an angle of a backrest, or the like is a desired position (so-called seat position) of a user when the user drives the vehicle M, and the seat position of the driver's seat is set or controlled by the in-vehicle equipment setup device 100. The seat heater/cooler is, for example, in-vehicle equipment 200 for adjusting a temperature of a driver's seat (which may include a passenger's seat or rear seats), and a seat temperature adjusting function of the seat is set or controlled by the in-vehicle equipment setup device 100. The door lock is, for example, in-vehicle equipment 200 having a security function which is activated when a user alights from the vehicle M and is away therefrom, and an operation mode or the like of the security function is set or controlled by the in-vehicle equipment setup device 100. The driving mode setting device is, for example, in-vehicle equipment 200 for changing various setting items associated with traveling (driving) of the vehicle M such as a traveling mode for automated driving, a normal traveling mode, a sport traveling mode, and a comfort traveling mode, and setting items corresponding to a driving mode or a traveling mode are set or controlled by the in-vehicle equipment setup device 100. The driving support device is, for example, in-vehicle equipment 200 for changing various setting items associated with a preventive safety function of curbing sudden change in behavior of the vehicle M by combining an anti-lock braking system (ABS) function, a traction control system (TCS) function, a sideslip prevention function, and the like or a driving support function such as an adaptive cruise control system (ACC) or a lane keeping assistance system (LKAS), and the setting items of the driving support function are set or controlled by the in-vehicle equipment setup device 100.

The in-vehicle equipment 200 that is set or controlled by the in-vehicle equipment setup device 100 is not limited to the aforementioned examples. That is, in addition to the aforementioned examples or instead of the aforementioned examples, other in-vehicle equipment may be included as the in-vehicle equipment 200 provided in the vehicle M. In this case, the other in-vehicle equipment is set or controlled by the in-vehicle equipment setup device 100.

The in-vehicle equipment setup device 100 sets set values of the in-vehicle equipment 200 (an air conditioning system 202 and a memory seat 204 in FIG. 1) mounted in the vehicle M for each user. Accordingly, the in-vehicle equipment setup device 100 stores user setting information 112 including set values with which setting or control of the in-vehicle equipment 200 has been changed when a user was previously in the vehicle M for each user. The in-vehicle equipment setup device 100 recognizes (identifies) a user who is currently in the vehicle M and sets the set values indicated by the corresponding user setting information 112 for the in-vehicle equipment 200. Accordingly, an application (hereinafter referred to as an “in-vehicle equipment application”) for recognizing (identifying) a user who is currently in the vehicle M and setting the set values indicated by the user setting information 112 corresponding to the recognized (identified) user for the in-vehicle equipment 200 is executed in the in-vehicle equipment setup device 100. The in-vehicle equipment application has at least a function of recognizing (identifying) a user (hereinafter referred to as a “user identifying function”) and a function of setting the set values indicated by the user setting information 112 for the in-vehicle equipment 200 (hereinafter referred to as a “set value setting function”)

In FIG. 1, an interface device 300 including a display 302 and an input unit 304 is illustrated as an example of a constituent for allowing the user identifying function of the in-vehicle equipment application executed in the in-vehicle equipment setup device 100 to recognize (identify) a user who is currently in the vehicle M. The interface device 300 may include, for example, a sounding device such as a buzzer or a speaker. The interface device 300 is provided, for example, in a center console or on a dashboard in the vicinity of the center in a vehicle width direction of the vehicle M and is configured as a touch panel through combination of the display 302 and the input unit 304. The display 302 includes a display device such as a liquid crystal display (LCD). The input unit 304 includes, for example, a detector such as a pressing force sensor for detecting a user's operation on a screen of the display 302. The input unit 304 may include, for example, an operation button (not illustrated) provided in a steering wheel on which a user performs a steering operation when the user causes the vehicle M to travel. When a user gets in the vehicle M, the user identifying function outputs a selection screen in which selection buttons for selecting a user of the vehicle M are arranged to the display 302 to display the selection screen and recognizes (identifies) a user who is currently in the vehicle M on the basis of information indicating an operation (which may be an operation performed by pressing an operation button (not illustrated) provided in the steering wheel) output from the input unit 304 when the user operates the selection buttons (for example, a tapping operation or a long pressing operation) on the screen of the display 302. The user identifying function may recognize (identify) a user who is currently in the vehicle M, for example, by acquiring information of the user correlated with a wireless portable key such as a smart key when the user carrying the portable key gets in the vehicle M in cooperation with the portable key. The set value setting function of the in-vehicle equipment application executed in the in-vehicle equipment setup device 100 sets the set values indicated by the corresponding user setting information 112 for the in-vehicle equipment 200 on the basis of the information of the user recognized (identified) by the user identifying function.

In the in-vehicle equipment setup device 100, the in-vehicle equipment application is normally activated regardless of whether a user is in the vehicle M. When the vehicle M has stopped for a long period of time (that is, no user is in the vehicle M in a long term), the in-vehicle equipment application is in a stopped state. Supply of electric power from a battery of the vehicle M to the in-vehicle equipment setup device 100 is cut off. Accordingly, consumption of electric power of the battery in the in-vehicle equipment setup device 100 can be curbed when the vehicle M has stopped for a long period of time. When the vehicle M has stopped for a long period of time, some functions of the in-vehicle equipment application in the in-vehicle equipment setup device 100 may be stopped. More specifically, out of the functions of the in-vehicle equipment application, only the user identifying function may be activated in a standby state and the set value setting function may be stopped. In this case, while the vehicle M has stopped for a long period of time, constituents associated with the user identifying function in the in-vehicle equipment setup device 100 may be supplied with electric power from the battery of the vehicle M, and supply of the other constituents including constituents associated with the set value setting function may be cut off. In this case, although less than in a case in which the in-vehicle equipment application is stopped and supply of electric power to the in-vehicle equipment setup device 100 is cut off, it is also possible to curb consumption of electric power of the battery when the vehicle M has stopped for a long period of time.

When a user gets in the vehicle M having stopped for a long period of time and, for example, the user switches an ignition switch (which may be an ignition key) which is not illustrated to an on state (IG_ON) or switches an accessory power supply to an on state (ACC_ON), all the constituents of the in-vehicle equipment setup device 100 are supplied with electric power from the battery, and the in-vehicle equipment application is started. Then, the in-vehicle equipment application first recognizes (identifies) the user in the vehicle M using the user identifying function and then sets the set values indicated by the user setting information 112 corresponding to the recognized (identified) user for the in-vehicle equipment 200 using the set value setting function. Here, when some functions of the in-vehicle equipment application are stopped, first, the user identifying function in a standby state is restored from the standby state, recognizes (identifies) the user in the vehicle M. Then, the set value setting function in the stopped state is started and sets the set values indicated by the user setting information 112 corresponding to the recognized (identified) user for the in-vehicle equipment 200.

At this time, the vehicle M may start after the user in the vehicle M has been recognized (identified) by the user identifying function of the in-vehicle equipment application and before the set values indicated by the user setting information 112 (hereinafter referred to as “user set values”) have been set for the in-vehicle equipment 200 by the set value setting function. In other words, the user may start traveling of the vehicle M before the set value setting function has been started to complete setting of the user set values for the in-vehicle equipment 200. Even in this case, that is, even when the vehicle M is traveling, the in-vehicle equipment setup device 100 (the in-vehicle equipment application) preferably continues to perform the process of setting the user set values for the in-vehicle equipment 200.

However, the in-vehicle equipment 200 of the vehicle M includes in-vehicle equipment which does not affect driving when setting or control thereof is changed at an arbitrary timing while the vehicle M is traveling and in-vehicle equipment which affects the driving when setting or control thereof is changed while the vehicle M is traveling. In FIG. 1, an air conditioning system 202 is illustrated as an example of the in-vehicle equipment 200 which does not affect the driving when setting or control thereof is changed at an arbitrary timing while the vehicle Mis traveling, and a memory seat 204 is illustrated as an example of the in-vehicle equipment 200 which affects the driving when setting or control thereof is changed while the vehicle M is traveling. For example, when settings of a temperature or a wind volume of the air conditioning system 202 are changed while the vehicle M is traveling, the temperature or the wind volume of air (wind) output to the cabin of the vehicle M is merely changed and thus does not affect the user's driving of the vehicle M. As an example of this in-vehicle equipment 200, a power window, a sunroof, a sunshade, an indoor lamp, a map light, an air conditioning system, a seat heater/cooler, and a door lock in addition to the air conditioning system 202 correspond to the in-vehicle equipment 200 which does not affect the driving when setting or control thereof is changed at an arbitrary timing while the vehicle M is traveling. On the other hand, for example, when settings (a seat position) of a position or a height of a seat surface or an angle of a backrest are changed while the vehicle Mis traveling, the memory seat 204 changes the user's posture when the user drives the vehicle M and thus affects the driving of the vehicle M. As an example of this in-vehicle equipment 200, a driving mode setting device and a driving support device in addition to the memory seat 204 correspond to the in-vehicle equipment 200 which affects the driving when setting or control thereof is changed at an arbitrary timing while the vehicle Mis traveling. Here, each of the driving mode setting device and the driving support device includes setting items which do not affect the driving when setting or control thereof is changed while the vehicle M is traveling and setting items which affect the driving when setting or control is changed while the vehicle Mis traveling together.

Accordingly, the in-vehicle equipment setup device 100 (the in-vehicle equipment application) temporarily stops the set value setting function when traveling of the vehicle Mis started. The in-vehicle equipment setup device 100 (the in-vehicle equipment application) acquires current set values set for the in-vehicle equipment 200 (hereinafter referred to as “current set values”) and compares the acquired current set value with the user set values. When there is in-vehicle equipment 200 in which the user set values and the current set values are different, that is, setting of the user set value has not been completed by the set value setting function, the in-vehicle equipment setup device 100 (the in-vehicle equipment application) notifies a user and inquires of a user about whether to set the user set values. When the user instructs to set the user set values for the notified in-vehicle equipment 200, the in-vehicle equipment setup device 100 (the in-vehicle equipment application) sets the user set values for the in-vehicle equipment 200 in which setting of the user set values has not been completed (hereinafter referred to as “non-set in-vehicle equipment 200N”). At this time, when the user set values are set for the non-set in-vehicle equipment 200N which affects the driving when setting or control thereof is changed while the vehicle Mis traveling, the in-vehicle equipment setup device 100 (the in-vehicle equipment application) ascertains a current traveling state of the vehicle M and performs setting of the user set values at a timing at which the driving is not affected when setting or control thereof is changed.

Accordingly, the in-vehicle equipment application has a function of performing a process of acquiring a current set value, a process of comparing the current set values with the user set values, a notifying and inquiring process for the non-set in-vehicle equipment 200N, and a process of setting the user set values for the non-set in-vehicle equipment 200N (hereinafter referred to as a “set value comparing and setting function”). The set value comparing and setting function is normally stopped in the in-vehicle equipment application and is started when traveling of the vehicle M is started in a state in which setting of the user set values for the in-vehicle equipment 200 using the set value setting function has not been completed.

In FIG. 1, a meter 400 including a display unit 402 is illustrated as an example of a constituent for ascertaining the current traveling state of the vehicle M using the set value comparing and setting function of the in-vehicle equipment application executed in the in-vehicle equipment setup device 100. The meter 400 is provided, for example, on a deep side (on a front side of the vehicle M) of a steering wheel in a driver's seat of the vehicle M and visually presents various types of information associated with traveling of the vehicle M (hereinafter referred to as “travel information”) such as a traveling state of the vehicle M as an image to a driver (user) using a display unit 402. The display unit 402 is a display device such as a liquid crystal display (LCD). The display unit 402 may include a display device for displaying an image of travel information on a surface of a front windshield of the vehicle M such as a head-up display (HUD). The image of travel information presented to the user by the display unit 402 includes, for example, an image of a speed meter (a speedometer) indicating a speed at which the vehicle Mis traveling or a rotation speed meter (a tachometer) indicating the number of revolutions (a rotation speed) of an internal combustion engine of the vehicle M. The image of travel information may include, for example, an image of a fuel consumption meter, a mileage indicator (such as a total mileage indicator: an odometer, a trip mileage indicator: a trip meter, or a possible mileage indicator), a time piece, or the like. The image of travel information may include, for example, an image indicating a discharging/charging state of electric power in a traveling battery of the vehicle M. The image of travel information may include, for example, an image indicating an operation or a warning of a driving support function (such as an LKAS or an ACC). Display of the image of travel information on the display unit 402 (which includes an HUD (not illustrated)) is performed by a control device (not illustrated) of the meter 400 or a meter display application which is executed in the control device (not illustrated). For example, by allowing a user to operate an operation button (not illustrated) provided in the vicinity of the steering wheel or the display unit 402 such that information desired by the user is displayed, display items of the image of travel information displayed on the display unit 402 (which includes an HUD (not illustrated)) are changed through the user's operation. This change of the image of travel information may be set or controlled, for example, by the control device (not illustrated) or the meter display application.

The meter 400 outputs travel information presented to a user by displaying an image on the display unit 402 to the in-vehicle equipment setup device 100. More specifically, for example, the control device (not illustrated) of the meter 400 or the meter display application outputs travel information indicating the traveling state (a traveling speed) of the vehicle M presented to a user using an image of a speed meter or travel information indicating the traveling state of the vehicle M presented to a user using an image indicating an operation or a warning of the driving support function to the in-vehicle equipment setup device 100.

The set value comparing and setting function of the in-vehicle equipment application executed in the in-vehicle equipment setup device 100 adjusts a timing at which the user set values are set for the non-set in-vehicle equipment 200N (that is, choose an appropriate timing) on the basis of the travel information indicating the current traveling state of the vehicle M output from the meter 400 and performs setting of the user set values. The meter 400 is an example of a “travel information presentation device.”

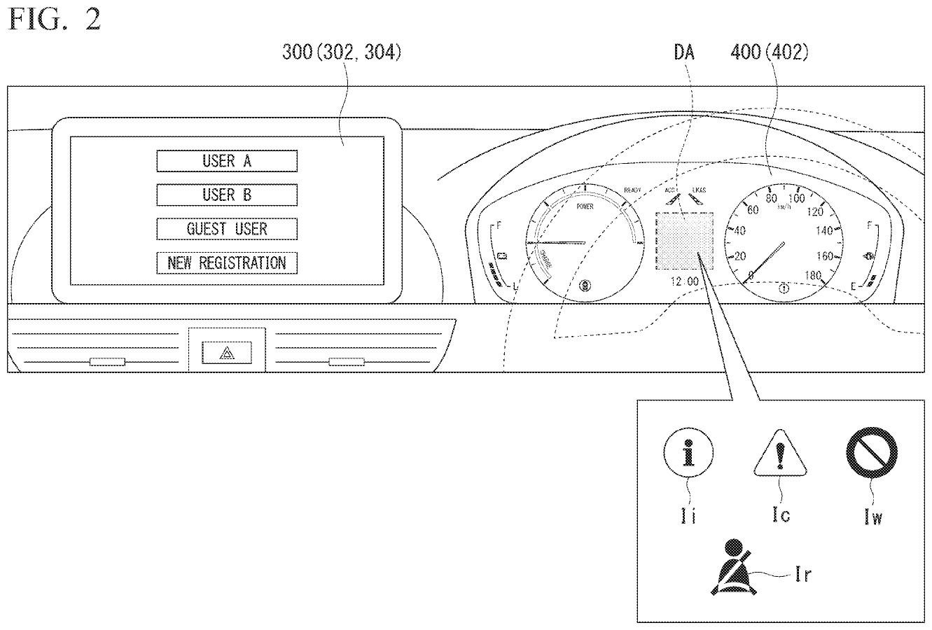

FIG. 2 is a diagram illustrating an example of an environment in which information (travel information including a traveling state) is presented in the vehicle M in which the in-vehicle equipment setup device 100 according to the embodiment is mounted. In FIG. 2, an example in which the interface device 300 (the display 302 and the input unit 304) is provided is illustrated, and an example in which a selection screen in which selection buttons for selecting a user in the vehicle M are arranged is displayed on the display 302 is illustrated. In the example of the selection screen illustrated in FIG. 2, selection buttons for “user A,” “user B,” “guest user,” and “new registration” are displayed. When a user operates one selection button, the user identifying function of the in-vehicle equipment application executed in the in-vehicle equipment setup device 100 recognizes (identifies) a user currently in the vehicle M (that is, a user who currently uses the vehicle M). Here, when the user operates the selection button for “user A,” user A registered when the user got in the vehicle M in the past is recognized (identified) as the user currently in the vehicle M. When the user operates the selection button for “user B,” user B other than user A registered when the user got in the vehicle M in the past is recognized (identified) as the user currently in the vehicle M. When the user operates the selection button for “guest user,” the user currently in the vehicle Mis recognized (identified) as a user who does not normally use the vehicle M (who temporarily uses the vehicle M). When the user operates the selection button for “new registration,” the user currently in the vehicle M is recognized (identified) as a user who did not get in the vehicle M in the past and who normally uses the vehicle M in the future. In this case, the user identifying function causes the display 302 to display an input screen for inputting registration names for identifying a user who is newly registered (for example, such as “user A” or “user B”) and registers information of the registration name for identifying the user who is newly registered on the basis of the user's operation on the input screen. The in-vehicle equipment setup device 100 stores information of the newly registered user (the registration name) in correlation with new user setting information 112.

In FIG. 2, an example in which the meter 400 (the display unit 402) is arranged is illustrated, and an example in which an image of travel information indicating the traveling state of the vehicle M is displayed on the display unit 402 is illustrated. In the example of the image of travel information illustrated in FIG. 2, an image indicating a discharging and charging state with electric power in the traveling battery is displayed on the left side of a display area of the display unit 402, an image of a speed meter is displayed on the right side thereof, and an icon indicating an operation or a warning of the driving support function (an LKAS or an ACC) is displayed in a display area DA therebetween. In FIG. 2, an information icon Ii for notifying a user that there is information on an operating state of the driving support function, a caution icon Ic for notifying that it has been ascertained that there is another vehicle (a preceding vehicle) in front in a traveling lane in the ACC, and a warning icon Iw for notifying that there is a likelihood of departure from the traveling lane in the LKAS are illustrated as examples of the icon displayed in the display area DA. The icons displayed in the display area DA are not limited to these examples. For example, the icons displayed in the display area DA may include a regulation icon Ir for prompting a user to wear a safety belt which is automatically displayed by the meter 400 to observe the laws or regulations.

When the user set values are set for the non-set in-vehicle equipment 200N, the set value comparing and setting function of the in-vehicle equipment application executed in the in-vehicle equipment setup device 100 sets the user set values at an appropriate timing such as a timing at which travel information output from the meter 400 indicates that the vehicle M stops (that is, the vehicle speed is 0 [km]) or a timing at which the caution icon Ic, the warning icon Iw, or the regulation icon Ir is not displayed in the display area DA.

### [Configuration of In-Vehicle Equipment Setup Device]

Returning to FIG. 1, the in-vehicle equipment setup device 100 includes, for example, a storage 110, a communicator 120, a setter 130, a settings comparator 140, and a notifier 150.

The setter 130, the settings comparator 140, and the notifier 150 include, for example, a hardware processor such as a central processing unit (CPU) and a storage device (a storage device including a non-transitory storage medium) storing a program (software), and functions of the constituents are realized by causing the processor to execute the program. Some or all of the constituents may be realized by hardware (a circuit unit including circuitry) such as a large-scale integration (LSI) circuit, an application-specific integrated circuit (ASIC), a field-programmable gate array (FPGA), or a graphics processing unit (GPU) or may be cooperatively realized by software and hardware. Some or all of the constituents may be realized by a dedicated LSI circuit. Here, the program (software) may be stored in a semiconductor memory device such as a read only memory (ROM), a random access memory (RAM), or a flash memory or a storage device (a storage device including a non-transitory storage medium) such as a hard disk drive (HDD) included in the in-vehicle equipment setup device 100 in advance or may be stored in a detachable storage medium (a non-transitory storage medium) such as a DVD or a CD-ROM and installed in the storage device included in the in-vehicle equipment setup device 100 by setting the storage medium into a drive device of the in-vehicle equipment setup device 100. The program (software) may be downloaded from another computer device via a network and installed in the storage device of the in-vehicle equipment setup device 100.

In the following description, the constituents such as the setter 130, the settings comparator 140, and the notifier 150 perform an operation or a process of performing setting or control of the in-vehicle equipment 200 in the vehicle M by executing the in-vehicle equipment application. The in-vehicle equipment application has the user identifying function, the set value setting function, and the set value comparing and setting function as described above, and the functions transition to other states such as a standby state and a stopped state in a time (period) in which the vehicle M stops or when traveling of the vehicle M is started. Accordingly, in the following description, the functions of the in-vehicle equipment application are referred to as a “user identifying function,” a “set value setting function,” and a “set value comparing and setting function” when they are distinguished. On the other hand, in the following description, the functions of the in-vehicle equipment application are also referred to as the “in-vehicle equipment application” when they are not distinguished.

For example, user setting information 112 is stored in the storage 110. The user setting information 112 is information in which each user is correlated with information associated with settings (hereinafter referred to as “setting information”) desired by the user for the in-vehicle equipment 200 mounted in the vehicle M. The setting information includes setting items of which settings or control can be changed in the in-vehicle equipment 200 or information indicating user set values of the setting items. The user setting information 112 is stored in the storage 110, for example, when a user newly registers the user himself or herself as a user who uses the vehicle M. When a plurality of users who use the vehicle M are registered, the user setting information 112 is stored such that the setting information is correlated with each user.

The communicator 120 communicates with the in-vehicle equipment 200 and the meter 400. The communicator 120 includes, for example, a communication interface for communication with the in-vehicle equipment 200 (the air conditioning system 202 and the memory seat 204 herein) or the meter 400 mounted in the vehicle M via a multiplex communication line such as a controller area network (CAN) communication line, a serial communication line, a radio communication network, or the like. In the following description, it is assumed that the communicator 120 communicates with the air conditioning system 202, the memory seat 204, and the meter 400 via the CAN communication line.

The setter 130 performs setting of the in-vehicle equipment 200 (which includes non-set in-vehicle equipment 200N) on the basis of the user setting information 112 stored in the storage 110. When user setting information 112 of a user who is currently in the vehicle M is stored in the storage 110, the setter 130 sets user set values indicated by the setting information included in the user setting information 112 corresponding to a current user for the in-vehicle equipment 200 (which includes non-set in-vehicle equipment 200N) via the communicator 120. That is, the setter 130 sets the user set values indicated by the setting information included in the user setting information 112 stored in the storage 110 for the corresponding in-vehicle equipment 200 through the operation of the set value setting function. When a process of setting the user set values for the non-set in-vehicle equipment 200N is performed, the setter 130 sets the user set values indicated by the setting information included in the user setting information 112 stored in the storage 110 for the corresponding non-set in-vehicle equipment 200N through the operation of the set value comparing and setting function.

When the user set values are set for the non-set in-vehicle equipment 200N, the setter 130 may acquire travel information from the meter 400 via the communicator 120 and adjust the timing at which the user set values are set until the traveling state indicated by the travel information or the display in the display area DA becomes suitable for setting the user set values.

The settings comparator 140 acquires current set values set for the in-vehicle equipment 200 via the communicator 120. More specifically, the settings comparator 140 acquires a current set value set for the air conditioning system 202 and a current set value set for the memory seat 204. That is, when traveling of the vehicle M is started in a state in which setting of the user set values for the in-vehicle equipment 200 has not been completed by the setter 130 through the operation of the set value setting function, the settings comparator 140 performs a current set value acquiring process of acquiring the current set values from the air conditioning system 202 and the memory seat 204 through the operation of the set value comparing and setting function.

Thereafter, the settings comparator 140 compares the acquired current set values with the corresponding user set values indicated by the setting information included in the user setting information 112. That is, when a process of comparing the current set values with the user set values is performed, the settings comparator 140 compares the current set values acquired from the air conditioning system 202 and the memory seat 204 with the corresponding user set values through the operation of the set value comparing and setting function.

When there is non-set in-vehicle equipment 200N according to a result of comparison between the current set values and the user set values, the settings comparator 140 causes the notifier 150 to perform notification of a user that there is non-set in-vehicle equipment 200N and inquiry of the user about whether to set the user set values for the non-set in-vehicle equipment 200N. At this time, the settings comparator 140 outputs information of the non-set in-vehicle equipment 200N to the notifier 150. The settings comparator 140 may output information of the user set values different from the current set values in the non-set in-vehicle equipment 200N to the notifier 150. That is, when it is ascertained that one or both of the air conditioning system 202 and the memory seat 204 are non-set in-vehicle equipment 200N, the settings comparator 140 causes the notifier 150 to perform the notification and inquiry processes for the non-set in-vehicle equipment 200N through the operation of the set value comparing and setting function. The settings comparator 140 may acquire travel information from the meter 400 via the communicator 120 and adjust a timing at which notification and inquiry of a user is performed until the traveling state indicated by the travel information or the display in the display area DA becomes suitable for notification of the presence of the non-set in-vehicle equipment 200N.

When information indicating that setting of the user set values for the notified non-set in-vehicle equipment 200N has been instructed is output from the notifier 150, the settings comparator 140 causes the setter 130 to perform setting of the user set values for the non-set in-vehicle equipment 200N. At this time, the settings comparator 140 outputs information of the non-set in-vehicle equipment 200N and information of the user set values different from the current set values to the setter 130. That is, the settings comparator 140 causes the setter 130 to perform the process of setting the user set values for the non-set in-vehicle equipment 200N through the operation of the set value comparing and setting function.

The notifier 150 performs notification and inquiry of a user on the basis of the information of the non-set in-vehicle equipment 200N and the information of the user set values different from the current set values which are output from the settings comparator 140. More specifically, the notifier 150 notifies the user that there is non-set in-vehicle equipment 200N, inquires of the user about whether to set the user set values for the non-set in-vehicle equipment 200N, outputs a notification screen for allowing the user to select a response in response to the inquiry to the interface device 300, and causes the display 302 to display the notification screen. Then, the notifier 150 acquires information when the user has performed a responding operation on the screen of the display 302 from the input unit 304 of the interface device 300 and outputs information indicating the user's response based on the acquired information to the settings comparator 140.

### [Example of In-Vehicle Equipment Setup Process in In-Vehicle Equipment Setup Device]

An example of a process flow of setting user set values for in-vehicle equipment 200 which is performed by the in-vehicle equipment setup device 100 will be described below.

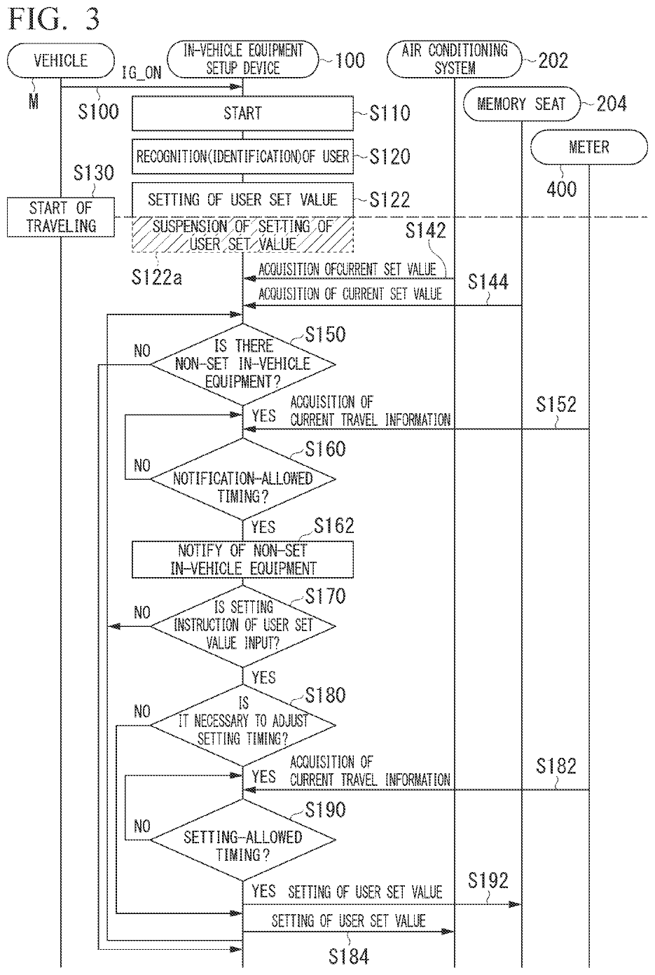

FIG. 3 is a sequence diagram illustrating an example of a process flow of setting set values (user set values) for the in-vehicle equipment 200 which is performed by the in-vehicle equipment setup device 100 according to the embodiment. FIG. 3 illustrates an example of operations on the vehicle M, operations (processes) performed by the in-vehicle equipment setup device 100, and information (data) exchange through CAN communication performed between the air conditioning system 202 and the memory seat 204 which are the in-vehicle equipment 200 mounted in the vehicle M and the meter 400 in the processes by the in-vehicle equipment setup device 100. The sequence diagram illustrated in FIG. 3 is an example of a process flow when user set values indicated by the user setting information 112 corresponding to a user in the vehicle M are set for the corresponding in-vehicle equipment 200 in a state in which the vehicle M has stopped for a long period of time and thus supply of electric power to the in-vehicle equipment setup device 100 is cut off.

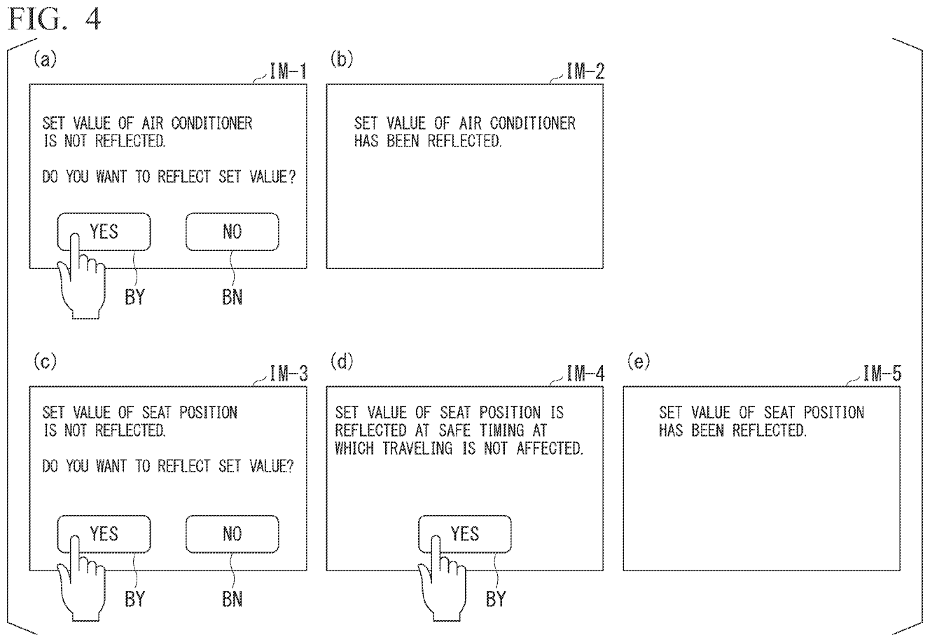

FIG. 4 is a diagram illustrating an example of a notification screen for notifying a user when the in-vehicle equipment setup device 100 according to the embodiment sets the set values (user set values) for the in-vehicle equipment 200. In (a) to (e) of FIG. 4, examples of the notification screen for notifying a user in the process steps which are performed by the in-vehicle equipment setup device 100 illustrated in FIG. 3 are illustrated. In the following description, the process steps performed by the in-vehicle equipment setup device 100 illustrated in FIG. 3 will be described appropriately with reference to the examples of the notification screen illustrated in FIG. 4.

A user gets in the vehicle M having stopped for a long period of time and, for example, an ignition switch (which may be an ignition key) which is not illustrated is switched to an on state (IG_ON) by the user (Step S100). Then, electric power from the battery is supplied to the in-vehicle equipment setup device 100. In the in-vehicle equipment setup device 100, the in-vehicle equipment application starts. Thereafter, starting of the in-vehicle equipment application in the in-vehicle equipment setup device 100 is completed (Step S110).

Accordingly, in the in-vehicle equipment setup device 100, the user identifying function of the in-vehicle equipment application operates to recognize (identify) the user in the vehicle M (Step S120). More specifically, the in-vehicle equipment setup device 100 outputs a selection screen in which selection buttons for selecting a user in the vehicle M are arranged to the display 302 to display the selection screen through the operation of the user identifying function and recognizes (identifies) the user who is currently in the vehicle M on the basis of information indicating the user's operation on the selection buttons output from the input unit 304.

Thereafter, in the in-vehicle equipment setup device 100, the set value setting function of the in-vehicle equipment application operates and sets the user set values indicated by the user setting information 112 corresponding to the recognized (identified) user for the corresponding in-vehicle equipment 200 (Step S122). More specifically, the setter 130 reads the user setting information 112 corresponding to the recognized (identified) user from the storage 110 and sets the user set values indicated by the read user setting information 112 for the corresponding in-vehicle equipment 200 via the communicator 120 through the operation of the set value setting function.

In the sequence diagram illustrated in FIG. 3, it is assumed that the user has started traveling of the vehicle M (Step S130) before setting of the user set values for the in-vehicle equipment 200 has been completed in Step S122. In this case, in the in-vehicle equipment setup device 100, the in-vehicle equipment application temporarily stops (suspends) the operation of the set value setting function (Step S122a). Here, it is assumed that setting of the user set values for the air conditioning system 202 and the memory seat 204 has not been completed.

In this case, in the in-vehicle equipment setup device 100, the set value comparing and setting function of the in-vehicle equipment application operates and first performs a process of acquiring current set values. More specifically, the settings comparator 140 acquires the current set values set for the air conditioning system 202 via the communicator 120 (Step S142). In addition, the settings comparator 140 acquires the current set values set for the memory seat 204 via the communicator 120 (Step S144). Then, the settings comparator 140 reads the user setting information 112 corresponding to the recognized (identified) user from the storage 110.

Thereafter, the set value comparing and setting function performs a process of comparing the current set values with the user set values. More specifically, the settings comparator 140 compares the corresponding user set values indicated by the user setting information 112 with the current set values of the air conditioning system 202 acquired in Step S142. Then, the settings comparator 140 ascertains whether there is non-set in-vehicle equipment 200N (presence thereof) on the basis of the result of comparison between the current set values and the user set values (Step S150). When it is ascertained in Step S150 that there is no non-set in-vehicle equipment 200N, the in-vehicle equipment application executed in the in-vehicle equipment setup device 100 ends this series of processes.

On the other hand, when it is ascertained in Step S150 that there is non-set in-vehicle equipment 200N, the set value comparing and setting function performs the notification and inquiry process for the non-set in-vehicle equipment 200N. Here, it is assumed that the air conditioning system 202 is the non-set in-vehicle equipment 200N. Accordingly, the settings comparator 140 acquires travel information current presented to the user by the meter 400 (hereinafter referred to as “current travel information”) via the communicator 120 (Step S152). Then, the settings comparator 140 determines whether the present is a timing suitable for performing notification and inquiry for the non-set in-vehicle equipment 200N (hereinafter referred to as a “notification-allowed timing”) on the basis of the acquired current travel information (Step S160). At this time, the settings comparator 140 determines whether the present is a notification-allowed timing by determining whether the current travel information satisfies a first condition.

The first condition is that the travel information is travel information of a type for calling attention to traveling of the vehicle M which is displayed in the display area DA of the display unit 402. That is, the settings comparator 140 determines that the present is not a notification-allowed timing when the caution icon Ic for notifying that it is ascertained that there is another vehicle (a preceding vehicle) in front in the traveling lane in the ACC or the warning icon Iw for notifying that there is a likelihood of departure from the traveling lane in the LKAS, or the like is displayed in the display area DA of the display unit 402, and determines that the present is a notification-allowed timing when the caution icon Ic or the warning icon Iw is not displayed.

The first condition may be that the travel information is travel information which is automatically presented to a user by the meter 400 and which is displayed in the display area DA of the display unit 402. In this case, for example, the settings comparator 140 determines that the present is not a notification-allowed timing when the regulation icon Ir or the like for prompting a user to wear a safety belt is displayed in the display area DA of the display unit 402 to observe the laws or regulations, and determines that the present is a notification-allowed timing when the regulation icon Ir or the like is not displayed.

When it is determined in Step S160 that the present is not a notification-allowed timing (the acquired current travel information does not satisfy the first condition), the settings comparator 140 repeatedly performs acquisition of the current travel information in the process of Step S152 and determination of whether the present is a notification-allowed timing in the process of Step S160 until it is determined that the present is a notification-allowed timing.

On the other hand, when it is determined in Step S160 that the present is a notification-allowed timing (the acquired current travel information satisfies the first condition), the settings comparator 140 outputs information indicating that the air conditioning system 202 is non-set in-vehicle equipment 200N to the notifier 150 and causes the notifier 150 to perform notification of the user that there is non-set in-vehicle equipment 200N (the air conditioning system 202) and inquiry of the user about whether to set the user set values for the air conditioning system 202. Accordingly, the notifier 150 notifies the user that the air conditioning system 202 is non-set in-vehicle equipment 200N by displaying a notification screen on the display 302 of the interface device 300 (Step S162). In (a) of FIG. 4, an example of a notification screen IM-1 at this time is illustrated. The notification screen IM-1 includes a message “set values for an air conditioner are not reflected” for notifying that the air conditioning system 202 is non-set in-vehicle equipment 200N, a message “are set values to be reflected?” for inquiring about whether to set the user set values for the air conditioning system 202, and a response button BY for instructing to set the user set values and a response button BN for instruction not to set the user set values as a response. A user can instruct whether to set the user set values for the air conditioning system 202 or not by operating one response button B (for example, performing a tapping operation) on the screen of the display 302. In (a) of FIG. 4, an example of a state in which it is instructed to set the user set values for the air conditioning system 202 by operating the response button BY is illustrated.

In the set value comparing and setting function, the notifier 150 acquires information when the user has performed a responding (instructing) operation on the screen of the display 302 from the input unit 304 of the interface device 300 and outputs information indicating the user's response based on the acquired information to the settings comparator 140. Then, the settings comparator 140 ascertains whether the information indicating the user's response output from the notifier 150 instructs to set the user set values (Step S170). When it is ascertained in Step S170 that the information indicating the user's response does not instruct to set the user set values, the settings comparator 140 returns the process flow to Step S150 and ascertains whether there is other non-set in-vehicle equipment 200N (whether it is present). When it is ascertained in Step S150 that there is other non-set in-vehicle equipment 200N, the settings comparator 140 and the notifier 150 repeatedly perform the process flow on the other non-set in-vehicle equipment 200N.

On the other hand, when it is ascertained in Step S170 that the information indicating the user's response instructs to set the user set values, the set value comparing and setting function performs the process of setting the user set values for the non-set in-vehicle equipment 200N. Accordingly, the settings comparator 140 ascertains whether it is necessary to adjust a timing at which the user set values are set for the non-set in-vehicle equipment 200N for which setting of the user set values is instructed (Step S180). Here, the in-vehicle equipment 200 in which it is necessary to adjust a timing at which the user set values are set is, for example, in-vehicle equipment 200 which affects driving when setting or control thereof is changed while the vehicle M is traveling. On the other hand, the in-vehicle equipment 200 in which it is not necessary to adjust the timing at which the user set values are set is in-vehicle equipment 200 which does not affect driving when setting or control thereof is changed at an arbitrary timing while the vehicle M is traveling.

Here, the non-set in-vehicle equipment 200N for which setting of the user set values is instructed is the air conditioning system 202. The air conditioning system 202 is in-vehicle equipment 200 which does not affect driving when setting or control thereof is changed at an arbitrary timing while the vehicle M is traveling. Accordingly, the settings comparator 140 ascertains that it is not necessary to adjust the timing at which the user set values are set for the air conditioning system 202 in Step S180. In this case, the settings comparator 140 outputs information indicating that the user set values are set for the air conditioning system 202 to the setter 130 and causes the setter 130 to set the user set values for the air conditioning system 202. Accordingly, the setter 130 sets the user set values for the air conditioning system 202 indicated by the user setting information 112 corresponding to the recognized (identified) user for the air conditioning system 202 (Step S184). That is, the setter 130 sets the user set values for the air conditioning system 202 in response to an instruction from the settings comparator 140 regardless of the traveling state of the vehicle M.

After the user set values are set for the air conditioning system 202 in Step S184, the setter 130 may output information indicating that setting of the user set values for the air conditioning system 202 has been completed to the notifier 150 and cause the notifier 150 to notify the user. In this case, the notifier 150 notifies the user that setting of the user set values for the air conditioning system 202 has been completed by displaying a notification screen on the display 302. In (b) of FIG. 4, an example of a notification screen IM-2 at this time is illustrated. The notification screen IM-2 includes a message “set values for air conditioner has been reflected” for notifying that setting of the user set values for the air conditioning system 202 has been completed. Accordingly, the user can ascertain that the instructed setting of the user set values for the air conditioning system 202 has been completed.

The setter 130 returns the process flow to Step S150 and ascertains whether there is other non-set in-vehicle equipment 200N (whether it is present). When it is ascertained that there is other non-set in-vehicle equipment 200N, the settings comparator 140 and the notifier 150 repeat the process on the other non-set in-vehicle equipment 200N.

Here, it is assumed that the memory seat 204 is the other non-set in-vehicle equipment 200N. Accordingly, the settings comparator 140 acquires current travel information from the meter 400 through the process of Step S152 and determines whether the present is a notification-allowed timing through the process of Step S160. Then, when it is determined in Step S160 that the present is a notification-allowed timing (the acquired current travel information satisfies the first condition), the settings comparator 140 outputs information indicating that the memory seat 204 is the other non-set in-vehicle equipment 200N to the notifier 150 and causes the notifier 150 to perform notification of the user that there is non-set in-vehicle equipment 200N (the memory seat 204) and inquiry of the user about whether to set the user set values for the memory seat 204. Accordingly, the notifier 150 displays a notification screen on the display 302 through the process of Step S162 and notifies the user that the memory seat 204 is non-set in-vehicle equipment 200N (Step S162). In (c) of FIG. 4, an example of the notification screen IM-3 is illustrated. Similar to the notification screen IM-1, the notification screen IM-3 includes a message “set values of seat position are not reflected” for notifying that the memory seat 204 is non-set in-vehicle equipment 200N, a message “are set values to be reflected?” for inquiring about whether to set the user set values for the memory seat 204, and a response button BY and a response button BN. A user can instruct whether to set the user set values for the memory seat 204 or not by operating one response button B (for example, performing a tapping operation) on the screen of the display 302. In (c) of FIG. 4, an example of a state in which it is instructed to set the user set values for the memory seat 204 by operating the response button BY is illustrated.

In the set value comparing and setting function, the notifier 150 acquires information when the user has performed a responding (instructing) operation on the screen of the display 302 from the input unit 304 of the interface device 300 and outputs information indicating the user's response based on the acquired information to the settings comparator 140. Then, the settings comparator 140 ascertains whether it is instructed to set the user set values in the process of Step S170. Here, it is assumed that it is instructed to set the user set values. In this case, the settings comparator 140 ascertains whether it is necessary to adjust the timing at which the user set values are set for the non-set in-vehicle equipment 200N (the memory seat 204) in which setting of the user set values has been instructed in the process of Step S180. The memory seat 204 is in-vehicle equipment 200 which affects driving when setting or control thereof is changed while the vehicle M is traveling. Accordingly, the settings comparator 140 ascertains that it is necessary to adjust the timing at which the user set values are set for the memory seat 204 in Step S180.

In this case, the settings comparator 140 may output information indicating that it is necessary to adjust the timing at which the user set values are set for the memory seat 204 to the notifier 150 and cause the notifier 150 to notify the user. In other words, the settings comparator 140 may cause the notifier 150 to notify the user that setting of the user set values for the memory seat 204 is suspended. In this case, the notifier 150 notifies the user that it is necessary to adjust the timing at which the user set values are set for the memory seat 204 by displaying a notification screen on the display 302. In (d) of FIG. 4, an example of the notification screen IM-4 at that time is illustrated. The notification screen IM-4 includes a message “set values of seat position are reflected at safe timing not affecting driving” for notifying that it is necessary to adjust the timing at which the user set values are set for the memory seat 204 and a response button BY for returning acknowledgement thereof. The user can represent acknowledgement that it is necessary to adjust the timing and to set the user set values for the memory seat 204 by operating the response button BY (for example, performing a tapping operation) on the screen of the display 302. In (d) of FIG. 4, an example of a state in which the response button BY is operated to return acknowledgement that the timing at which the user set values are set for the memory seat 204 is adjusted is illustrated.

When it is ascertained in Step S180 that it is necessary to adjust the timing at which the user set values are set for the memory seat 204, the settings comparator 140 acquires current travel information from the meter 400 via the communicator 120 again (Step S182). Then, the settings comparator 140 determines whether the present is a timing suitable for setting the user set values for the non-set in-vehicle equipment 200N (hereinafter referred to as a “setting-allowed timing”) on the basis of the acquired current travel information (Step S190). At this time, the settings comparator 140 determines whether the present is a setting-allowed timing by determining whether the current travel information satisfies a second condition.

The second condition is that the travel information indicates that the vehicle M stops (that is, the vehicle speed is 0 [km]). That is, the settings comparator 140 determines that the present is not a setting-allowed timing when the vehicle M does not stop (that is, the vehicle speed is not 0 [km]) and determines that the present is a setting-allowed timing when the vehicle M stops.

When it is determined in Step S190 that the present is not a setting-allowed timing (the acquired current travel information does not satisfy the second condition), the settings comparator 140 repeats acquisition of the current travel information through the process of Step S182 and determination of whether the present is a setting-allowed timing through the process of Step S190 until it is determined that the present is a setting-allowed timing.

On the other hand, when it is determined in Step S190 that the present is a setting-allowed timing (the acquired current travel information satisfies the second condition), the settings comparator 140 outputs information indicating that the user set values are to be set for the memory seat 204 to the setter 130 and causes the setter 130 to set the user set values for the memory seat 204. Accordingly, the setter 130 sets the user set values for the memory seat 204 indicated by the user setting information 112 corresponding to the recognized (identified) user for the memory seat 204 (Step S192). That is, the setter 130 sets the user set values for the memory seat 204 in accordance with an instruction output from the settings comparator 140 at the adjusted timing.

After the user set values are set for the memory seat 204 in the process of Step S192, the setter 130 may output information indicating that setting of the user set values for the memory seat 204 has been completed to the notifier 150 and cause the notifier 150 to notify the user. In this case, the notifier 150 notifies the user that setting of the user set values for the memory seat 204 has been completed by displaying a notification screen on the display 302. In (e) of FIG. 4, an example of a notification screen IM-5 at this time is illustrated. Similar to the notification screen IM-2, the notification screen IM-5 includes a message “set values for seat position has been reflected” for notifying that setting of the user set values for the memory seat 204 has been completed. Accordingly, the user can ascertain that the instructed setting of the user set values for the memory seat 204 has been completed.

The setter 130 returns the process flow to Step S150, and the in-vehicle equipment application executed in the in-vehicle equipment setup device 100 performs the processes of Steps S150 to S184 until it is ascertained that there is no non-set in-vehicle equipment 200N. When it is ascertained that there is no non-set in-vehicle equipment 200N, the in-vehicle equipment application executed in the in-vehicle equipment setup device 100 ends this series of processes.

As described above, the in-vehicle equipment setup device 100 according to the embodiment sets user set values indicated by user setting information 112 corresponding to a user (a registered user) for the corresponding in-vehicle equipment 200. When there is in-vehicle equipment 200 for which setting of the user set values has not been completed (non-set in-vehicle equipment 200N), the in-vehicle equipment setup device 100 according to the embodiment notifies the user that there is non-set in-vehicle equipment 200N and inquires of the user about whether the user set values are to be set for the non-set in-vehicle equipment 200N. When the user instructs to set the user set values in response to the inquiry, the in-vehicle equipment setup device 100 according to the embodiment adjusts the timing at which the user set values are actually set for the non-set in-vehicle equipment 200N until an appropriate timing comes on the basis of the traveling state of the vehicle M or information notified of the user from another device such as the meter 400. Then, the in-vehicle equipment setup device 100 according to the embodiment sets the user set values for the non-set in-vehicle equipment 200N when the appropriate timing has come. Accordingly, the in-vehicle equipment setup device 100 according to the embodiment does not perform setting of the user set values, for example, even when there is in-vehicle equipment 200 for which setting of the user set values has not been completed after a user has gotten in the vehicle M and until the vehicle M starts (traveling of the vehicle M is started), that is, there is no case in which the user needs to perform setting or control of the in-vehicle equipment 200 or the user set values are set at a timing which affects driving. This is effective for a user registered as a user who normally uses the vehicle M (convenience for the user is improved). With the vehicle M in which the in-vehicle equipment setup device 100 according to the embodiment is mounted, it is possible to allow the vehicle M to continuously travel more safely.

In the in-vehicle equipment setup device 100 according to the embodiment, the in-vehicle equipment setup device 100 adjusts the timing at which the user set values are set such that the timing becomes an appropriate timing. However, there may be in-vehicle equipment 200 for which it is necessary to adjust a timing at which setting or control thereof is changed. In this case, the in-vehicle equipment setup device 100 may set the user set values for such in-vehicle equipment 200 without adjusting the timing at which the user set values are set. More specifically, when it is ascertained that there is in-vehicle equipment 200 for which it is necessary to adjust the timing at which the user set values are set in the process of Step S180 of the sequence diagram illustrated in FIG. 3, the process of Step S184 may be performed without performing the processes of Steps S182 and S190. The process of setting the in-vehicle equipment which is performed by the in-vehicle equipment setup device 100 in this case can be easily achieved and thus detailed description thereof will be omitted.

In the embodiment, a case in which the in-vehicle equipment setup device 100 acquires current travel information from the meter 400 to determine an appropriate timing has been described above. However, instead of or in addition to the current travel information, other information may be used as the information for determining an appropriate timing at which the user set values are set. In this case, a process equivalent to that in the embodiment can be performed as the process of setting in-vehicle equipment which is performed by the in-vehicle equipment setup device 100. Accordingly, detailed description of the in-vehicle equipment setup device 100 when the in-vehicle equipment setup device 100 determines the appropriate timing at which the user set values are set using other information instead of or in addition to the current travel information will be omitted.

The in-vehicle equipment setup device 100 according to the embodiment described above is an in-vehicle equipment setup device 100 for performing setting for activating in-vehicle equipment 200 mounted in a vehicle M for each user of the vehicle M, the in-vehicle equipment setup device 100 including: a storage 110 configured to store user setting information 112 including setting information on settings of in-vehicle equipment 200 desired by a user for each user; a setter 130 configured to set a set value indicated by the setting information included in the user setting information 112 of a selected user for the corresponding in-vehicle equipment 200; a settings comparator 140 configured to acquire a current set value which is a set value currently set from the in-vehicle equipment 200 and to compare the acquired current set value with a user set value which is a set value indicated by the setting information included in the user setting information 112 of the selected user; and a notifier 150 configured to notify the user of at least information on settings of the in-vehicle equipment 200, wherein, when there is non-set in-vehicle equipment 200N which is in-vehicle equipment 200 of which the user set value is different from the current set value according to a result of the comparison, the settings comparator 140 causes the notifier 150 to notify that there is non-set in-vehicle equipment 200N on the basis of travel information including a traveling state of the vehicle M, and the setter 130 sets the user set value for the non-set in-vehicle equipment 200N on the basis of the travel information when a setting instruction for instructing to set the user set value for the non-set in-vehicle equipment 200N notified by the notifier 150 is input by the user. Accordingly, it is possible to perform setting for the in-vehicle equipment for each user at appropriate timing. As a result, with the vehicle M in which the in-vehicle equipment setup device 100 is mounted, it is possible to improve convenience for a user registered as a user who normally uses the vehicle M and to continuously allow the vehicle M to travel more safely.

The aforementioned embodiment can be expressed as follows.

An in-vehicle equipment setup device for performing setting for activating in-vehicle equipment mounted in a vehicle for each user of the vehicle, the in-vehicle equipment setup device comprising:
a hardware processor; and
a storage device configured to store a program,
wherein the hardware processor reads and executes the program stored in the storage device to perform:
setting, out of user setting information which is stored in a storage and includes setting information on settings of in-vehicle equipment desired by a user for each user, a set value indicated by the setting information included in the user setting information of a selected user for the corresponding in-vehicle equipment;
acquiring a current set value which is a set value currently set from the in-vehicle equipment;
comparing the acquired current set value with a user set value which is a set value indicated by the setting information included in the user setting information of the selected user;
causing a notifier, which is configured to notify the user of at least information on settings of the in-vehicle equipment, to notify that there is non-set in-vehicle equipment on the basis of travel information including a traveling state of the vehicle when there is non-set in-vehicle equipment which is in-vehicle equipment of which the user set value is different from the current set value according to a result of the comparison; and
setting the user set value for the non-set in-vehicle equipment on the basis of the travel information when a setting instruction for instructing to set the user set value for the non-set in-vehicle equipment notified by the notifier is input by the user.

While a mode for carrying out the present invention has been described above in conjunction with an embodiment, the present invention is not limited to the embodiment and can be subjected to various modifications and substitutions without departing from the gist of the present invention.

What is claimed is:

1. An in-vehicle equipment setup device for performing setting for activating in-vehicle equipment mounted in a vehicle for each user of the vehicle, the in-vehicle equipment setup device comprising:
a storage configured to store user setting information including setting information on settings of in-vehicle equipment desired by a user for each user;
a setter configured to set a set value indicated by the setting information included in the user setting information of a selected user for the corresponding in-vehicle equipment;
a settings comparator configured to acquire a current set value which is a set value currently set from the in-vehicle equipment and to compare the acquired current set value with a user set value which is a set value indicated by the setting information included in the user setting information of the selected user; and
a notifier configured to notify the user of at least information on settings of the in-vehicle equipment,
wherein, when there is non-set in-vehicle equipment which is in-vehicle equipment of which the user set value is different from the current set value according to a result of the comparison, the settings comparator causes the notifier to notify that there is non-set in-vehicle equipment on the basis of travel information including a traveling state of the vehicle, and
wherein the setter sets the user set value for the non-set in-vehicle equipment on the basis of the travel information when a setting instruction for instructing to set the user set value for the non-set in-vehicle equipment notified by the notifier is input by the user.

2. The in-vehicle equipment setup device according to claim 1, wherein the settings comparator acquires the current set value and compares the current set value with the user set value after the vehicle has started.

3. The in-vehicle equipment setup device according to claim 2, further comprising a communicator configured to perform communication between the in-vehicle equipment and a travel information presentation device for presenting the travel information of the vehicle to the user,
wherein the settings comparator acquires the current set value via the communicator,
wherein the settings comparator acquires current travel information which is the travel information currently presented to the user by the travel information presentation device via the communicator, and
wherein the settings comparator causes the notifier not to notify that there is non-set in-vehicle equipment when the acquired current travel information satisfies a first condition.

4. The in-vehicle equipment setup device according to claim 3, wherein the first condition is that the current travel information is the travel information of a type for calling attention to traveling of the vehicle.

5. The in-vehicle equipment setup device according to claim 3, wherein the first condition is that the current travel information is the travel information which is automatically presented to the user by the travel information presentation device.

6. The in-vehicle equipment setup device according to claim 3, wherein the setter acquires the current travel information via the communicator after the setting instruction has been input,
wherein the setter suspends setting of the user set value for the non-set in-vehicle equipment when the acquired current travel information satisfies a second condition, and
wherein the setter causes the notifier to notify that setting of the user set value for the non-set in-vehicle equipment is suspended.

7. The in-vehicle equipment setup device according to claim 6, wherein the second condition is that the current travel information is the travel information indicating that a traveling speed of the vehicle is zero.

8. An in-vehicle equipment setup method that is performed by a computer of an in-vehicle equipment setup device for performing setting for activating in-vehicle equipment mounted in a vehicle for each user of the vehicle, the in-vehicle equipment setup method comprising:
setting, out of user setting information which is stored in a storage and includes setting information on settings of in-vehicle equipment desired by a user for each user, a set value indicated by the setting information included in the user setting information of a selected user for the corresponding in-vehicle equipment;
acquiring a current set value which is a set value currently set from the in-vehicle equipment;
comparing the acquired current set value with a user set value which is a set value indicated by the setting information included in the user setting information of the selected user;
causing a notifier, which is configured to notify the user of at least information on settings of the in-vehicle equipment, to notify that there is non-set in-vehicle equipment on the basis of travel information including a traveling state of the vehicle when there is non-set in-vehicle equipment which is in-vehicle equipment of which the user set value is different from the current set value according to a result of the comparison; and
setting the user set value for the non-set in-vehicle equipment on the basis of the travel information when a setting instruction for instructing to set the user set value for the non-set in-vehicle equipment notified by the notifier is input by the user.

9. A non-transitory computer-readable storage medium storing a program, the program causing a computer of an in-vehicle equipment setup device for performing setting for activating in-vehicle equipment mounted in a vehicle for each user of the vehicle to perform:
setting, out of user setting information which is stored in a storage and includes setting information on settings of in-vehicle equipment desired by a user for each user, a set value indicated by the setting information included in the user setting information of a selected user for the corresponding in-vehicle equipment;
acquiring a current set value which is a set value currently set from the in-vehicle equipment;
comparing the acquired current set value with a user set value which is a set value indicated by the setting information included in the user setting information of the selected user;
causing a notifier, which is configured to notify the user of at least information on settings of the in-vehicle equipment, to notify that there is non-set in-vehicle equipment on the basis of travel information including a traveling state of the vehicle when there is non-set in-vehicle equipment which is in-vehicle equipment of which the user set value is different from the current set value according to a result of the comparison; and
setting the user set value for the non-set in-vehicle equipment on the basis of the travel information when a setting instruction for instructing to set the user set value for the non-set in-vehicle equipment notified by the notifier is input by the user.
